(19) United States
(12) Patent Application Publication
(10) Pub. No.: US 2014/0050378 A1
(43) Pub. Date: Feb. 20, 2014

(54) SYSTEM AND METHOD FOR DETECTING MATERIALS OR DISEASE STATES USING MULTI-ENERGY COMPUTED TOMOGRAPHY

(71) Applicants: Souma Sengupta, Cupertino, CA (US); Sandeep Dutta, Waukesha, WI (US); Toshihiro Rifu, Suwon-si (KR); Ajay Narayanan, Bangalore (IN); Bipul Das, Bangalore (IN); Melissa Megumi Shiraishi Kuriki, Sao Paulo (BR); Pedro Alves Lemos Neto, Sao Paulo (BR); Roberto Caldeira Cury, Sao Paulo (BR); Carlos Eduardo Rochitte, Sao Paulo (BR)

(72) Inventors: Souma Sengupta, Cupertino, CA (US); Sandeep Dutta, Waukesha, WI (US); Toshihiro Rifu, Suwon-si (KR); Ajay Narayanan, Bangalore (IN); Bipul Das, Bangalore (IN); Melissa Megumi Shiraishi Kuriki, Sao Paulo (BR); Pedro Alves Lemos Neto, Sao Paulo (BR); Roberto Caldeira Cury, Sao Paulo (BR); Carlos Eduardo Rochitte, Sao Paulo (BR)

(73) Assignees: INSTITUTO DO CORACAO, Rio do Sul-SC (BR); GENERAL ELECTRIC COMPANY, Schenectady, NY (US)

(21) Appl. No.: 13/585,632

(22) Filed: Aug. 14, 2012

(51) Int. Cl. G06K 9/00

(52) U.S. Cl. 382/131

(57) ABSTRACT

The disclosed embodiments relate to characterizing or quantifying an element or composition of interest within an imaged volume. In accordance with one embodiment, high and low energy images are acquired of a volume of interest using a polychromatic emission source. The high and low energy images are processed to generate monochromatic images. Based on the observed attenuation within the monochromatic images, one or more elements or compositions of interest are characterized within the imaged volume.

### BACKGROUND

Non-invasive imaging technologies allow images of the internal structures or features of a patient to be obtained without performing an invasive procedure on the patient. In particular, such non-invasive imaging technologies rely on various physical principles, such as the differential transmission of X-rays through the target volume or the reflection of acoustic waves, to acquire data and to construct images or otherwise represent the observed internal features of the patient.

For example, in computed tomography (CT) and other X-ray based imaging technologies, X-ray radiation spans a subject of interest, such as a human patient, and a portion of the radiation impacts a detector where the image data is collected. In digital X-ray systems a photo detector produces signals representative of the amount or intensity of radiation impacting discrete pixel regions of a detector surface. The signals may then be processed to generate an image that may be displayed for review. In CT systems a detector array, including a series of detector elements, produces similar signals through various positions as a gantry is displaced around a patient.

In the images produced by such systems, it may be possible to identify and examine the internal structures and organs within a patient's body. It may also be desirable to characterize the tissues that are present in the imaged volume, such as based on the presence or absence of a chemical or molecule of interest. However, in practice, such characterization may be difficult to achieve. In particular, in conventional computed tomography (CT), the X-ray attenuation proximity of multiple tissues at any given energy may make tissue classification difficult to achieve. That is, although materials have a distinct attenuation profile across different energies, tissue separation is not trivial as tissues are a mixture of different materials with range of densities that vary across subjects.

### BRIEF DESCRIPTION

In one embodiment, a computer-implemented method of image processing is provided. The method includes the act of acquiring a first set of images at a first energy spectrum and a second set of images at a second energy spectrum. The first set of images and the second set of images are reconstructed to generate paired material decomposition images. Respective first monochromatic images and second monochromatic images are generated based on the paired material decomposition images. A composition or element of interest within an image volume is characterized based on the attenuation by the composition or element of interest within the respective first monochromatic images and second monochromatic images.

In a further embodiment, one or more non-transitory computer-readable media are provided. The computer-readable media encode one or processor-executable routines. The one or more routines, when executed by a processor, cause acts to be performed comprising: acquiring a first set of images at a first energy spectrum and a second set of images at a second energy spectrum; reconstructing the first set of images and the second set of images to generate paired material decomposition images; generating respective first monochromatic images and second monochromatic images based on the paired material decomposition images; and characterizing a composition or element of interest within an image volume based on the attenuation by the composition or element of interest within the respective first monochromatic images and second monochromatic images.

In an additional embodiment, a processor-based system is provided. The processor-based system comprises a memory structure encoding one or more processor-executable routines. The routines, when executed cause acts to be performed comprising: acquiring a first set of images at a first energy spectrum and a second set of images at a second energy spectrum; reconstructing the first set of images and the second set of images to generate paired material decomposition images; generating respective first monochromatic images and second monochromatic images based on the paired material decomposition images; and characterizing a composition or element of interest within an image volume based on the attenuation by the composition or element of interest within the respective first monochromatic images and second monochromatic images. The processor-based system also comprises a processing component configured to access and execute the one or more routines when encoded by the memory structure.

### BRIEF DESCRIPTION OF THE DRAWINGS

These and other features and aspects of embodiments of the present invention will become better understood when the following detailed description is read with reference to the accompanying drawings in which like characters represent like parts throughout the drawings, wherein:

FIG. 1 is a schematic illustration of an embodiment of a computed tomography (CT) system configured to acquire CT images of a patient and process the images in accordance with aspects of the present disclosure;

FIG. 2 is an embodiment of a plot of two different polychromatic source spectra generated by an X-ray source;

FIG. 3 is a process flow diagram illustrating an embodiment of a method for determining an amount of a contrast agent in an image using two or more monochromatic images simulated from two or more polychromatic images, in accordance with aspects of the present disclosure; and

FIG. 4 depicts an image of a heart and corresponding identified microcalcifications, in accordance with aspects of the present disclosure.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the following discussion is generally provided in the context of medical imaging, it should be appreciated that the present techniques are not limited to such medical contexts. Indeed, the provision of examples and explanations in such a medical context is only to facilitate explanation by providing instances of real-world implementations and applications. However, the present approaches may also be utilized in other contexts, such as the non-destructive inspection of manufactured parts or goods (i.e., quality control or quality review applications), and/or the non-invasive inspection of packages, boxes, luggage, and so forth (i.e., security or screening applications).

Tissue characterization or classification may be desirable in various clinical contexts to assess the tissue being characterized for pathological conditions and/or to assess the tissue for the presence of various elements, chemicals or molecules of interest. However, tissue characterization in imaging studies, such as using computed tomography (CT), may be problematic due to tissues being a mixture of different materials with range of densities that vary across subjects.

By way of example, in certain contexts it may be desirable to identify calcification (e.g., coronary plaque) within the vasculature of a patient as such calcification may be indicative of present or potential atherosclerosis. However, in conventional CT imaging approaches, only dense and large coronary plaques are readily detectable, usually based on a threshold radiodensity within the image data (e.g., a pixel or voxel having an intensity of 130 Hounsfield units (HU) or greater). However, it may be desirable to detect calcifications, such as microcalcifications below this threshold (i.e., small and/or less dense calcifications). As discussed herein, in various implementations, a multi-energy CT approach having high spatial resolution is employed to detect calcifications (e.g., microcalcifications) below conventional thresholds (e.g., 130 HU).

In particular, as described herein, a spectral imaging or filtering approach is used to classify and/or separate tissue from spectral CT images. The approach utilizes images at two different energy levels derived from the original dual energy scans and a set of known attenuation parameters to model the tissues. The model of the tissue in the joint energy space is based on the material composition and density of the tissue constituents. Such a model-based approach allows the dynamic property of tissues with varying density and material properties to be accounted for. The resultant density or concentration maps of the composition or element of interest within the tissue enables separation and/or characterization of the tissue in the images.

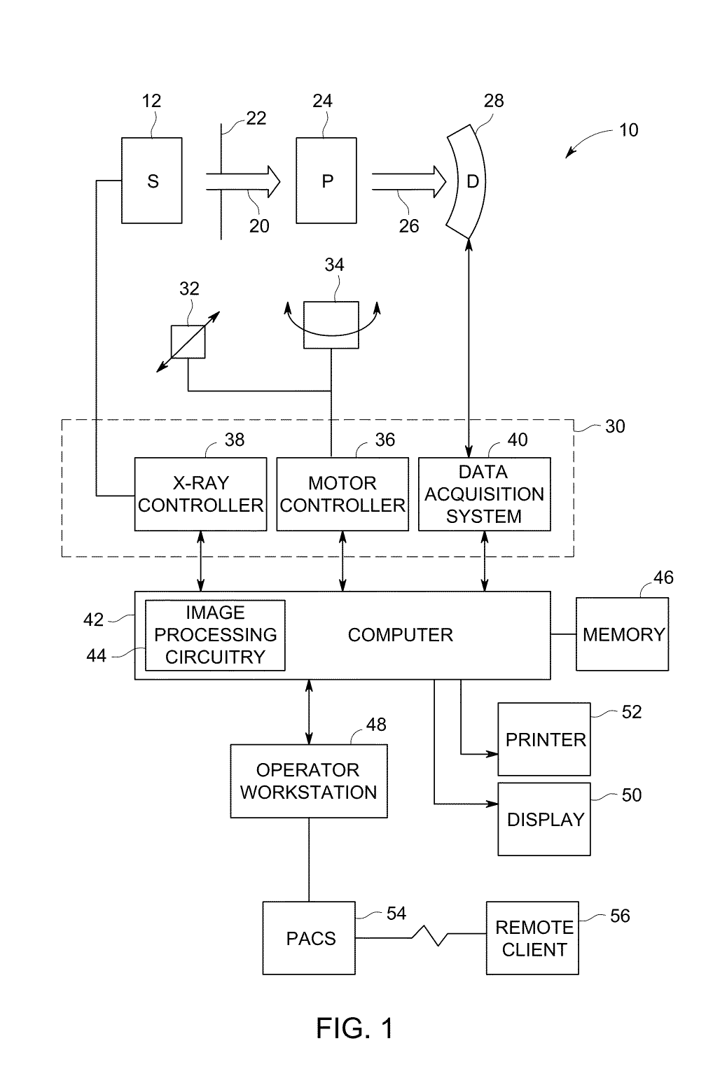

With the foregoing discussion in mind, FIG. 1 illustrates an embodiment of an imaging system 10 for acquiring and processing image data in accordance with aspects of the present disclosure. In the illustrated embodiment, system 10 is a computed tomography (CT) system designed to acquire X-ray projection data, to reconstruct the projection data into a tomographic image, and to process the image data for display and analysis. The CT imaging system 10 includes an X-ray source 12. As discussed in detail herein, the source 12 may include one or more X-ray sources, such as an X-ray tube or solid state emission structures. The X-ray source 12, in accordance with present embodiments, is configured to emit an X-ray beam 20 at one or more energies. For example, the X-ray source 12 may be configured to switch between relatively low energy polychromatic emission spectra (e.g., at about 80 kVp) and relatively high energy polychromatic emission spectra (e.g., at about 140 kVp). As will be appreciated, the X-ray source 12 may also be operated so as to emit X-rays at more than two different energies, though dual-energy embodiments are discussed herein to simplify explanation. Similarly, the X-ray source 12 may emit at polychromatic spectra localized around energy levels (i.e., kVp ranges) other than those listed herein. Indeed, selection of the respective energy levels for emission may be based, at least in part, on the anatomy being imaged and the chemical or molecules of interest for tissue characterization.

In certain implementations, the source 12 may be positioned proximate to a collimator 22 used to define the size and shape of the one or more X-ray beams 20 that pass into a region in which a subject 24 (e.g., a patient) or object of interest is positioned. The subject 24 attenuates at least a portion of the X-rays. Resulting attenuated X-rays 26 impact a detector array 28 formed by a plurality of detector elements. Each detector element produces an electrical signal that represents the intensity of the X-ray beam incident at the position of the detector element when the beam strikes the detector 28. Electrical signals are acquired and processed to generate one or more scan datasets.

A system controller 30 commands operation of the imaging system 10 to execute examination and/or calibration protocols and to process the acquired data. With respect to the X-ray source 12, the system controller 30 furnishes power, focal spot location, control signals and so forth, for the X-ray examination sequences. The detector 28 is coupled to the system controller 30, which commands acquisition of the signals generated by the detector 28. In addition, the system controller 30, via a motor controller 36, may control operation of a linear positioning subsystem 32 and/or a rotational subsystem 34 used to move components of the imaging system 10 and/or the subject 24. The system controller 30 may include signal processing circuitry and associated memory circuitry. In such embodiments, the memory circuitry may store programs, routines, and/or encoded algorithms executed by the system controller 30 to operate the imaging system 10, including the X-ray source 12, and to process the data acquired by the detector 28 in accordance with the steps and processes discussed herein. In one embodiment, the system controller 30 may be implemented as all or part of a processor-based system such as a general purpose or application-specific computer system.

The source 12 may be controlled by an X-ray controller 38 contained within the system controller 30. The X-ray controller 38 may be configured to provide power and timing signals to the source 12. In addition, in some embodiments the X-ray controller 38 may be configured to selectively activate the source 12 such that tubes or emitters at different locations within the system 10 may be operated in synchrony with one another or independent of one another. In certain embodiments discussed herein, the X-ray controller 38 may be configured to provide fast-kVp switching of the X-ray source 12 so as to rapidly switch the source 12 to emit X-rays at the respective polychromatic energy spectra in succession during an image acquisition session. For example, in a dual-energy imaging context, the X-ray controller 38 may operate the X-ray source 12 so that the X-ray source 12 alternately emits X-rays at the two polychromatic energy spectra of interest, such that adjacent projections are acquired at different energies (i.e., a first projection is acquired at high energy, the second projection is acquired at low energy, the third projection is acquired at high energy, and so forth). In one such implementation, the fast-kVp switching operation performed by the X-ray controller 38 yields temporally registered projection data.

The system controller 30 may include a data acquisition system (DAS) 40. The DAS 40 receives data collected by readout electronics of the detector 28, such as sampled analog signals from the detector 28. The DAS 40 may then convert the data to digital signals for subsequent processing by a processor-based system, such as a computer 42. In other embodiments, the detector 28 may convert the sampled analog signals to digital signals prior to transmission to the data acquisition system 40. The computer 42 may include or communicate with one or more non-transitory memory devices 46 that can store data processed by the computer 42, data to be processed by the computer 42, or instructions to be executed by a processor of the computer 42. For example, a processor of the computer 42 may execute one or more sets of instructions stored on the memory 46, which may be a memory of the computer 42, a memory of the processor, firmware, or a similar instantiation. In accordance with present embodiments, the memory 46 stores sets of instructions that, when executed by the processor, perform image processing methods as discussed herein.

As discussed below, the memory 46 may also store instructions for the conversion of two polychromatic measurements to material decomposition pairs (e.g., water-iodine or other suitable material decomposition image pairs) and in turn generating monochromatic images (e.g., a first monochromatic image at a first energy and a second monochromatic image at a second energy) from two or more polychromatic image acquisitions. Generally stated, such an X-ray spectral imaging approach enable the simulation of an image that would be produced from a monochromatic acquisition (i.e., imaging at a single energy) even though the actual X-ray emissions used to generate projection data are polychromatic in nature.

The computer 42 may also be adapted to control features enabled by the system controller 30 (i.e., scanning operations and data acquisition), such as in response to commands and scanning parameters provided by an operator via an operator workstation 48. The system 10 may also include a display 50 coupled to the operator workstation 48 that allows the operator to view relevant system data, imaging parameters, raw imaging data, reconstructed data, contrast agent density maps produced in accordance with the present disclosure, and so forth. Additionally, the system 10 may include a printer 52 coupled to the operator workstation 48 and configured to print any desired measurement results. The display 50 and the printer 52 may also be connected to the computer 42 directly or via the operator workstation 48. Further, the operator workstation 48 may include or be coupled to a picture archiving and communications system (PACS) 54. PACS 54 may be coupled to a remote system 56, radiology department information system (RIS), hospital information system (HIS) or to an internal or external network, so that others at different locations can gain access to the image data.

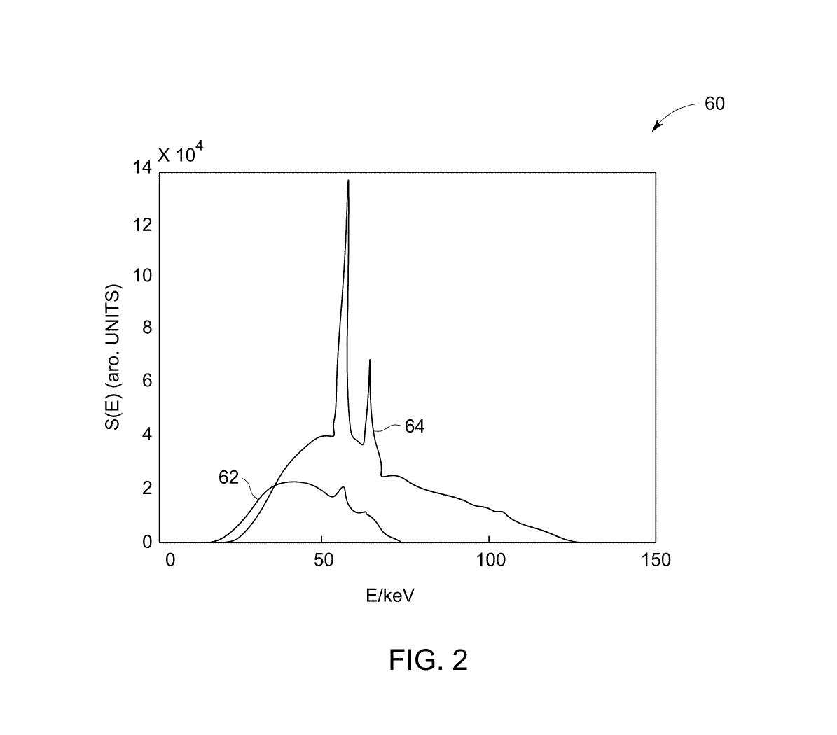

As noted above, the X-ray source 12 may be configured to emit X-rays at more than one energy spectrum. That is, though such emissions may be generally described or discussed as being at a particular energy (e.g., 80 kvP, 140 kVp, and so forth), the respective X-ray emissions at a given energy are actually along a continuum or spectrum and may, therefore, constitute a polychromatic emission centered at, or having a peak strength at, the target energy. By way of example, a plot 60 illustrating two different source spectra that may be emitted by the X-ray source 12 of FIG. 1 is depicted in FIG. 2. Specifically, the plot 60 of FIG. 2 provides a first source spectrum 62 and a second source spectrum 64. The plot 60 depicts the strength of the first and second source spectra 62, 64 on the Y-axis as a function of an emitted energy on the X-axis.

As depicted, the first source spectrum 62 represents an emission by the X-ray source 12 of approximately 80 kVp, or peak kilovolts, which represents the highest energy emitted in the first source spectrum 62. In accordance with present embodiments, this represents a first energy emitted by the X-ray source 12, and may also be referred to as a first polychromatic energy emission. The second source spectrum 64 represents an emission by the X-ray source of approximately 140 kVp. In one embodiment, the first source spectrum 62 may represent a lower energy emission and the second source spectrum 62 may represent a higher energy emission. As may be appreciated, these two source spectra may result in different images being generated. Furthermore, the images so produced may be composite images (i.e., polychromatic images) containing attenuation information across the entire source spectra, rather than at a discreet single energy.

In accordance with present embodiments, it may be desirable to generate simulated images that are true monochromatic images. As defined herein, a simulated monochromatic image is intended to denote an image that is produced (using at least two polychromatic images obtained using two different polychromatic source spectra) by an image processing device to simulate how an image would look, or what the data in an image would be, if the image were obtained using a true monochromatic source (i.e., a source that emits only one energy with no bandwidth). In accordance with certain embodiments discussed herein, such monochromatic images may be used to characterize or quantify an element or composition of interest in the imaged volume, such as calcium in the form of microcalcifications.

Keeping in mind the operation of the system 10 and, specifically, the X-ray source 12 discussed above with respect to FIGS. 1 and 2, FIG. 3 illustrates a process flow diagram of an embodiment of a method 70 of image processing. Any suitable application-specific or general-purpose computer having a memory and processor may perform the method 70. By way of example, as noted above with respect to FIG. 1, the computer 42 and associated memory 46 may be configured to perform the method 70. For example, the memory 46, which may be any tangible, non-transitory, machine-readable medium (e.g., an optical disc, solid state device, chip, firmware), may store one or more sets of instructions that are executable by a processor of the computer 42 to perform the steps of method 70. In accordance with present embodiments, the processor, in performing method 70, may generate one or more maps or images that may be used to classify, characterize, or quantify tissue or tissue constituents and/or to identify molecules or compositions of interest within the imaged volume. For example, in one implementation, microcalcifications may be identified within a volume that would otherwise not be characterized as having a detectable degree of calcification (such as due to having a corresponding radiodensity of less than 130 HU within the generated images).

In the depicted implementation, the method 70 includes obtaining (block 74) a first polychromatic X-ray image 72 (e.g., a high energy image) at a first source energy that is polychromatic and a second polychromatic X-ray image 76 (e.g., a low energy image) at a second source energy that is polychromatic. The acts associated with block 74 may be performed at the time of imaging the subject 24, or post-imaging. For example, obtaining the first polychromatic image 72 may include executing an imaging protocol using the system 10 of FIG. 1 to generate the first image 72. Alternatively or additionally, the acts associated with block 74 may include accessing the first image 72 from memory, such as from a local storage device or from an image archiving system, such as the PACS 54 of FIG. 1. Therefore, the acts associated with block 74 may be performed by the system 10, or by a computing device local to or remote from the facility in which the image is acquired. The second polychromatic X-ray image 76 may be obtained in a similar manner to the first image 72, though at a second, different source energy, which is polychromatic.

In the depicted example of an implementation, the high energy images 72 and low energy images 76 are used in a projection-based reconstruction process (block 78) that uses known attenuation curves 80 for two or more compositions of interest along the polychromatic spectra used in generating the high energy images 72 and low energy images 76. In the depicted implementation, the projection based reconstruction process 78 mathematically transforms the low and high kVp attenuation projection measurements (i.e., images 72 and 76) into effective material densities of material pairs like iodine-water, and so forth. This is referred to as material decomposition (MD), and produces image pairs, i.e., first material decomposition images 82 and second material decomposition images 84.

The first and second material decomposition images 82, 84 are subsequently used to simulate (block 90) first and second monochromatic X-ray images 92, 94. By way of non-limiting example, the first and second monochromatic images 92, 94 may be simulated using X-ray spectral imaging techniques, as discussed herein. In accordance with certain embodiments, X-ray spectral imaging techniques may enable the measurement of a spectral response of an image at a single energy, rather than at a plurality of energies as is obtained using a polychromatic source. That is, the simulated monochromatic images 92, 94 are the images that would have been generated if the X-ray source 12 had generated X-ray photons as a single energy expressed in Kilo electron Volts (KeV). The monochromatic images 92, 94 thus generated have reduced effects of beam hardening. One example of a system that is configured to perform X-ray spectral imaging (e.g., spectral CT) is a Gemstone Spectral Imaging system available from General Electric Company, such as the Discovery CT 750HD from GE Healthcare.

Thus, the first monochromatic image 92 generated in accordance with block 90 may be simulated to contain data representative of a spectral response at a first monochromatic energy (e.g., a high energy). It should be noted that the first monochromatic energy may or may not correspond to the peak energy of the polychromatic source spectrum used to obtain the first polychromatic image 72 (i.e., the peak energy of the first source energy). Similarly, the second monochromatic image 94 generated in accordance with block 90 may be simulated to contain data representative of a spectral response at a second monochromatic energy (e.g., a low energy). Again, the second monochromatic energy may or may not correspond to the peak energy of the second source energy used to obtain the second polychromatic image 76.

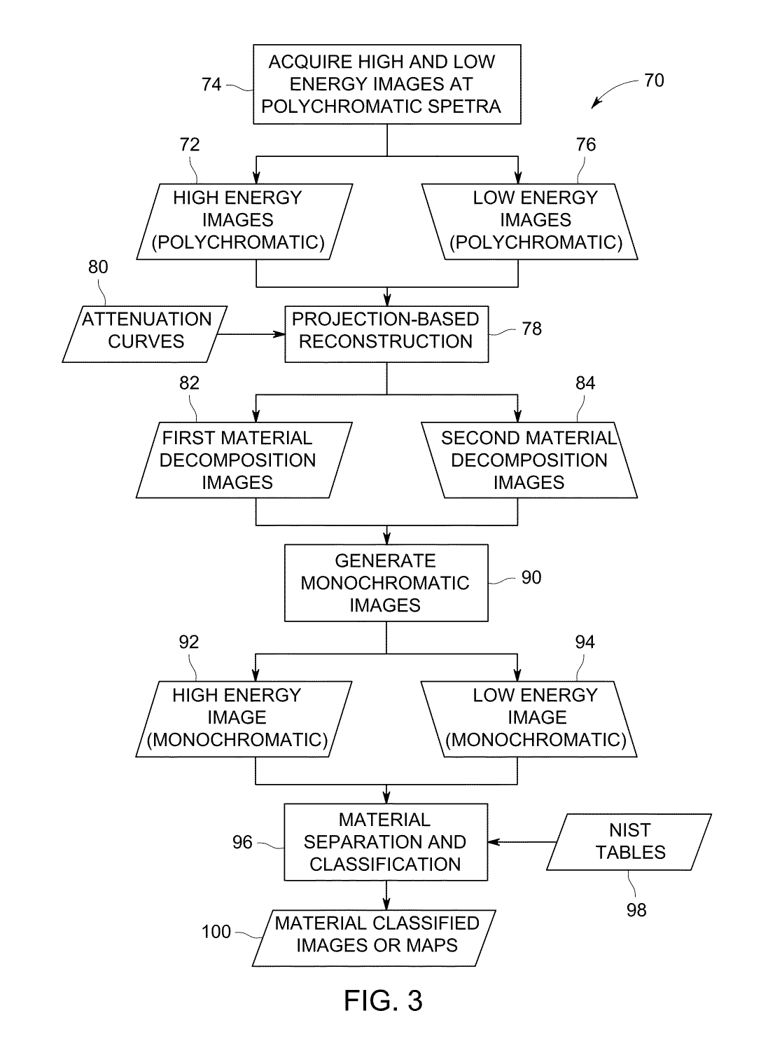

As depicted in FIG. 3, the monochromatic images 92, 94 thus obtained enable the use of the observed X-ray attenuation for separating (block 96) different materials within the image volume, such as based upon the attenuation properties of materials of interest that are documented in National Institute of Standards and Technology tables 98 or in comparable standards or literature describing the X-ray attenuation properties of different materials at different X-ray energies. This information may be used to generate images or maps 100 depicting the spatial location of the materials of interest within the imaged volume. In particular, in certain embodiments pixels or voxels of the image may be classified (either qualitatively or quantitatively) based on the presence, concentration, and/or density of a composition or element of interest (e.g., calcium, iron, and so forth) within the corresponding tissue.

With the foregoing general description in mind, the following describes particular embodiments and equations suitable for certain implementations. In particular, as discussed herein, a spectral filtering and/or spectral imaging approach is employed in certain implementations that generates probability maps for each tissue in multi-energy space wherein the probabilities correspond to the likely presence of a composition or element of interest at each voxel or pixel. The filter design incorporates variations in the tissue due to composition, density of individual constituents and their mixing proportions. In addition, it also provides a framework to incorporate zero-mean Gaussian noise.

As discussed herein, and to elaborate on points raised above, every point in spectral space is a projection of the attenuation response of a physical region (voxel) across multiple energies as measured by the CT system. Response at a given point is expressed by a linear attenuation coefficient μ_{L}(Eᵢ). If the voxel has only one type of tissue, the response would be a point (μ_{L}^{T1}(E₁), μ_{L}^{T1}(E₂)) in spectral space and in the real system it would be ellipse centered at (μ_{L}^{T1}(E₁), μ_{L}^{T1}(E₂)) having radii proportional to system noise across the energies. In addition, the density variation that occurs across patients and anatomy translates this point along the trajectory of a straight line. A linear attenuation coefficient μ_{L}(Eᵢ) at energy Eᵢ is related to the density as μ_{L}(Eᵢ)=μ(Eᵢ)ρ, where μ(Eᵢ) is the mass attenuation coefficient. Furthermore, if the voxel has more than one type of material, μ_{L}(Eᵢ) can be decomposed into its constituents' attenuation response in linear ideal mixture by:

μ_{L}(Eᵢ)=Σⱼ₌₁^{N}αⱼμⱼ(Eᵢ)ρⱼ (1)

where μ_{L}(Eᵢ) is the linear attenuation of the given tissue t computed as the linear combination of N materials having mass attenuation values given by μⱼ and density ρⱼ·αⱼ gives the volume fraction of each of the materials present in the voxel of interest.

As discussed herein, given a tissue T, the spectral filter design can be considered as generating a tissue probability map (such as map 100 of FIG. 3). The probability map of a given tissue is determined through both modeling the physics of X-ray attenuation of a given tissue (elemental, compound, or mixture model) and learning from priors, including anatomical priors, regional sampling, and responses of extracted tissues from multiple patient data. Thus, mathematically, a probability map in two-dimensional (2D) spectral space (E1,E2) may be defined as:

p_{E1,E2}^{T}(μ_{E1},μ_{E2})=p_{E1}^{T}(μ_{E1})·p_{E2/E1}^{T}(μ_{E2}/μ_{E1}) (2)

where μ_{Ei}, is the response of the tissue T at a given radiation energy Ei.

The present approach can be used to design spectral filters for tissues with any number of constituents having bounded density ranges. Given the X-ray response curves of the constituents and the range of densities of each constituent, the signals across the range of mixing proportions for a tissue of interest can be generated. As will be appreciated, the mixing proportions can be defined based on the literature, based on empirical results or user experience, or otherwise specified by the user or system.

The mixture response or universal set of the tissue map point clouds on the spectral space may be assigned as a certain event, that is:

p_{E1,E2}^{T}(μ_{E1},μ_{E2})=1 (3)

Depending upon the noise of the system, the point spread function of noise may be convolved with this map. This map, after normalizing, is the tissue probability map in spectral space and, in some embodiments may take the form of an image depicting the concentration or density of one or more elements within an image slice or volume. The same approach can be extended to N tissues and can be used to extract the relevant tissue under the following conditions: the interclass variation is higher than the system noise (i.e., (σ_{class1}−σ_{class2})>>ε, where ε represents the system noise); mean shift of the tissue class is not higher than κ, where κ>μ_{actual}−μₑₓₚₑᵣᵢₘₑₙₜₐₗ; and where the tissue is a mixture of unique and finite numbers of materials having a bounded proportion of its constituents. These conditions will be satisfied in most practical or clinical applications.

By way of example in demonstrating the use of the present approach in quantifying or characterizing particular tissue of interest within a set of multi-energy images, cardiac tissue was imaged using dual-energy CT protocols with the purpose of identifying and/or quantifying microcalcifications within the tissue. In one implementation, the image acquisition was performed in axial mode, with a rotation time between 0.5 to 0.8 seconds. A microcalcification was defined on 70 KeV monochromatic images as having a radiodensity less than 130 HU.

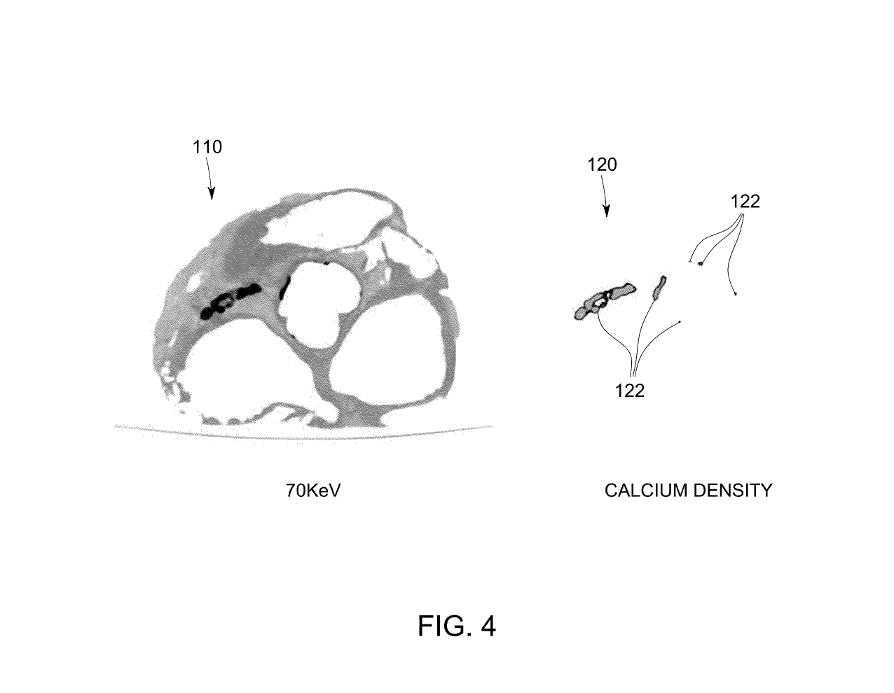

An example of such images and tissue characterization is depicted in FIG. 4, where the left pane of the image depicts a 70 KeV monochromatic image of a slice through the heart being imaged. The right pane constitutes a map 120 or image depicting those portions 122 of the heart determined to be calcifications or microcalcifications based on a material separation and/or classification step 96 (FIG. 3) performed using the known attenuation properties of calcium at the energies being simulated in the monochromatic images. In the depicted example, microcalcifications (i.e., calcifications having <130 HU) were detectable using the spectral imaging approach discussed herein. That is, calcifications that were smaller and/or less dense than what was typically detectable using conventional thresholding were detectable using spectral imaging.

While the preceding example relates to characterization of calcium within tissue, it should be appreciated that, using suitable monochromatic images and corresponding attenuation information, other compositions, elements, or molecules may be identified and characterized in accordance with the present approach. For example, in a further implementation, iron or other suitable elements of interest may be characterized within the imaged tissue.

Based on the maps or images generated (such as the right pane of FIG. 4), the portions of the images characterized by the composition of interest may be automatically scored (i.e., used to generate a quantitative or qualitative score or ranking) to provide a measure of risk to a reviewer, i.e., the score corresponds or correlates to an empirically determined level of risk. For example, in the context of microcalcifications, a low density scoring system may be employed to quantify (such as on a scale of 1-10 or 1-100) or otherwise indicate the prevalence of microcalcifications within an imaged volume. As will be appreciated, though calcium is one example of a factor that may be used in determining a score, other factors may also be employed in addition to or instead of calcium density. For example, calcium volume and/or distribution may also be utilized as scoring criteria or factors.

Such a scoring system may be based on the density of calcium within a given area or be based on a density weighted volume with respect to the microcalcifications. In various implementations, such a score may then be related or correlated to the presence or absence of atherosclerosis or to a stage of progression of atherosclerosis. Conversely, in the context or measuring or assessing other compositions, a corresponding scoring system may be utilized to provide a reviewer with a measure of disease state progression or, more simplistically, the density or concentration of the composition of interest within the imaged volume or regions of the imaged volume.

This written description uses examples to disclose the present subject matter, including the best mode, and also to enable any person skilled in the art to practice the present approaches, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method of image processing, comprising:
acquiring a first set of images at a first energy spectrum and a second set of images at a second energy spectrum;
reconstructing the first set of images and the second set of images to generate paired material decomposition images;
generating respective first monochromatic images and second monochromatic images based on the paired material decomposition images; and
characterizing a composition or element of interest within an image volume based on the attenuation by the composition or element of interest within the respective first monochromatic images and second monochromatic images.

2. The method of claim 1, wherein acquiring the first set of images at the first energy spectrum and the second set of images at the second energy spectrum comprises acquiring a set of high energy images in alternation with a set of low energy images about the image volume.

3. The method of claim 1, wherein reconstructing the first set of images and the second set of images comprises performing a projection-based reconstruction attenuation curve information suitable for generating the paired material decomposition images.

4. The method of claim 1 wherein each of the first and second monochromatic images represent a simulation of an image that would be generated if an X-ray source generated X-ray photons at a single energy.

5. The method of claim 1, wherein the first monochromatic images simulate data representative of spectral response at a first monochromatic energy and the second monochromatic images simulate data representative of spectral response at a second monochromatic energy.

6. The method of claim 1, wherein characterizing the composition or element of interest within the image volume is based upon known attenuation properties of the composition or element of interest at the X-ray energies represented by the first monochromatic images and the second monochromatic images.

7. The method of claim 1, wherein characterizing the composition or element of interest within the image volume comprises generating a map or image depicting the spatial location of the composition or element of interest within the imaged volume.

8. The method of claim 7, wherein the map or image comprises a probability map wherein the probabilities correspond to the likely presence of a composition or element of interest at each voxel or pixel.

9. The method of claim 7, wherein the map or image depicts the density or concentration of the composition or element of interest at each pixel.

10. The method of claim 1, comprising generating a score corresponding to a disease state based on the characterization of the composition or element of interest within the image volume.

11. One or more non-transitory computer-readable media encoding one or more processor-executable routines, wherein the one or more routines, when executed by a processor, cause acts to be performed comprising:
acquiring a first set of images at a first energy spectrum and a second set of images at a second energy spectrum;
reconstructing the first set of images and the second set of images to generate paired material decomposition images;
generating respective first monochromatic images and second monochromatic images based on the paired material decomposition images; and
characterizing a composition or element of interest within an image volume based on the attenuation by the composition or element of interest within the respective first monochromatic images and second monochromatic images.

12. The one or more non-transitory computer-readable media of claim 11, wherein acquiring the first set of images at the first energy spectrum and the second set of images at the second energy spectrum comprises acquiring a set of high energy images in alternation with a set of low energy images about the image volume.

13. The one or more non-transitory computer-readable media of claim 11, wherein characterizing the composition or element of interest within the image volume is based upon known attenuation properties of the composition or element of interest at the X-ray energies represented by the first monochromatic images and the second monochromatic images.

14. The one or more non-transitory computer-readable media of claim 11, wherein characterizing the composition or element of interest within the image volume comprises generating a map or image depicting the spatial location of the composition or element of interest within the imaged volume.

15. The one or more non-transitory computer-readable media of claim 11, wherein the one or more routines, when executed by the processor, cause further acts to be performed comprising:
generating a score corresponding to a disease state based on the characterization of the composition or element of interest within the image volume.

16. A system, comprising:
a memory structure encoding one or more processor-executable routines, wherein the routines, when executed cause acts to be performed comprising:
acquiring a first set of images at a first energy spectrum and a second set of images at a second energy spectrum;
reconstructing the first set of images and the second set of images to generate paired material decomposition images;
generating respective first monochromatic images and second monochromatic images based on the paired material decomposition images; and
characterizing a composition or element of interest within an image volume based on the attenuation by the composition or element of interest within the respective first monochromatic images and second monochromatic images;
a processing component configured to access and execute the one or more routines encoded by the memory structure.

17. The processor-based system of claim 16, wherein acquiring the first set of images at the first energy spectrum and the second set of images at the second energy spectrum comprises acquiring a set of high energy images in alternation with a set of low energy images about the image volume.

18. The processor-based system of claim 16, wherein characterizing the composition or element of interest within the image volume is based upon known attenuation properties of the composition or element of interest at the X-ray energies represented by the first monochromatic images and the second monochromatic images.

19. The processor-based system of claim 16, wherein characterizing the composition or element of interest within the image volume comprises generating a map or image depicting the spatial location of the composition or element of interest within the imaged volume.

20. The processor-based system of claim 16, wherein the routines, when executed by the processor, cause further acts to be performed comprising:
generating a score corresponding to a disease state based on the characterization of the composition or element of interest within the image volume.
